(19) United States
(12) Patent Application Publication
(10) Pub. No.: US 2016/0287024 A1
(43) Pub. Date: Oct. 6, 2016

(54) Food and Beverage Tray

(71) Applicant: Dan Bach, City of Industry, CA (US)

(72) Inventor: Dan Bach, City of Industry, CA (US)

(21) Appl. No.: 15/096,990

(22) Filed: Apr. 12, 2016

Related U.S. Application Data
(63) Continuation-in-part of application No. 14/338,074, filed on Jul. 22, 2014.

(51) Int. Cl. A47J 47/14

(52) U.S. Cl. CPC A47J 47/14

(57) ABSTRACT

A food and beverage tray that is particularly useful in consuming fast food or snack meals. The food and beverage tray is uniquely designed so that the entire fast-food or snack meal may be held with one hand, leaving the other hand free for eating.

### CROSS-REFERENCE TO RELATED APPLICATIONS

This is a continuation in part of U.S. Ser. No. 14/338,074 filed Jul. 22, 2014.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to food and beverage trays. More particularly, the invention concerns a novel hand-held, fast food and beverage tray that is designed so that the entire fast-food or snack meal may be held with one hand, leaving the other hand free for eating.

2. Description of the Prior Art

A number of food and beverage trays of various configurations have been suggested in the past. Typically these trays are constructed from a foldable cardboard material and are generally provided with a series of openings for receiving utensils, beverage containers and various types of food items.

Exemplary of the prior art food and beverage trays is the tray disclosed in U.S. Pat. No. 4,757,937 issued to Maio. The Maio tray comprises an easy set-up tray wherein in addition to the usual well defined by a tray for receiving food products, there is a top wall for receiving other products, including containers for drinks and the like. Each tray is of a one-piece construction and is provided in a substantially flat knocked-down state. When it is desired to erect or set-up the tray, side walls thereof are grasped and pulled apart with the result that the tray automatically erects and is locked in its erected or set-up position. The top wall is connected to the side walls by reversely foldable connecting walls so as to provide for a rigid structure.

A somewhat similar tray is disclosed in U.S. Pat. No. 5,421,459 issued to Mazzotti. The Mazzotti tray exhibits a support and containment plane provided with a plurality of compartments one of which extends beneath the support and containment plane thereby constituting a manual grip for the tray while contemporaneously providing a suitable seating for the top or can.

Exemplary of yet another prior art food tray, is the tray disclosed in U.S. Pat. No. 6,401,927 issued to Sorensen. The Sorensen tray comprises a pop-up food tray for combination meals and functions as a lap or seat mounted support for the typical sandwich, drink cup and french fry container related to eating drive-in fast-food. The tray includes a multiple spring cam mechanism for accommodating a wide variety of drink cup sizes and provides a fold out wall that catches spilled food particles, a foldable condiment serving tub, a fold out cover that contains the used food containers for convenient disposal, punch out game pieces, a random number spinner wheel and a wide variety of games printed on the tray.

### SUMMARY OF THE INVENTION

Fast food and snacks are difficult to eat unless the consumer has a table or flat surface on which to set their meal. Particularly at outdoor events, such as concerts, fairs, and sporting events, the consumer has difficulty eating multiple food items and a beverage without a flat surface on which to place the meal. Similarly, condiments are difficult to use unless the consumer is sitting at a table, or placing the food items on a flat surface.

By way of brief summary, one form of the food tray of the present invention that provides a novel solution of the foregoing problems, includes a bottom wall having a central portion provided with a plurality of finger receiving openings; a pair of substantially parallel side walls extending upward from the bottom wall, one of the sidewalls being provided with a generally centrally disposed finger receiving opening; a pair of substantially parallel end walls extending upward from the bottom wall; and a top wall connected to the sidewalls and to the end walls and overlying the bottom wall, the top wall having a pair of longitudinally spaced food container receiving openings; a generally centrally disposed beverage container receiving opening; and a pair of longitudinally spaced condiment container receiving openings disposed intermediate the pair of longitudinally spaced food container receiving openings.

With the forgoing in mind, it is an object of the invention to provide a novel food and beverage tray that is particularly useful in consuming fast food or snack meals. More particularly, the food and beverage tray is uniquely designed so that the entire fast-food or snack meal may be held with one hand, leaving the other hand free for eating.

Another object of the invention is to provide a food and beverage tray of the aforementioned character that enables the fast food customer to consume multiple food items and a drink without a flat surface on which to place the meal.

Another object of the invention is to provide a food and beverage tray of the type described in the preceding paragraphs that enables the fast food customer to carry in one hand a beverage container, two food items, condiments and a napkin.

Another object of the invention is to provide a food tray of the class described in the preceding paragraph in which the food and beverage tray is uniquely designed to include strategically located thumb and finger holes that are positioned on the bottom and on one side of the tray so that the weight of the beverage container is at the center of gravity of the tray.

Another object of the invention is to provide a food tray which contains recessed openings of such a shape and depth as to accommodate food containers (bags) which stand upright, thus allowing the food to be removed and eaten with one free hand.

Another object of the invention is to provide a food tray that can be shipped and stored in a generally planar configuration and one that can be quickly and easily erected into a usable configuration.

Another object of the invention is to provide a food tray of the character described in the preceding paragraph in which the top wall of the tray includes a downwardly foldable structural support member, which upon the erection of the tray spans the top and bottom wall of the tray, lockably engages the bottom wall and securely maintains the top and bottom wall and a spaced configuration.

The foregoing, as well as other objectives of the invention, are achieved by the novel food tray illustrated in the drawings and described in the specification which follows.

### BRIEF DESCRIPTION OF THE DRAWINGS

FIG. 1 is a generally perspective, illustrative view showing one form of the food and beverage tray of the invention being held by the user.

FIG. 2 is a generally perspective bottom view illustrating one method of holding the beverage and food tray of the invention.

FIG. 3 is a generally perspective bottom view illustrating an alternate method of holding the beverage and food tray of the invention.

FIG. 4 is a top plan view of the food and beverage tray illustrated in FIG. 1.

FIG. 5 is a view taken along lines 5-5 of FIG. 4.

FIG. 6 is a view taken along lines 6-6 of FIG. 4.

FIG. 7 is an end view of the food and beverage tray illustrated in FIG. 1.

FIG. 8 is a bottom plan view of the food and beverage tray illustrated in FIG. 1.

FIG. 9 is a top plan view of an alternate form of the food and beverage tray of the invention.

FIG. 10 is a top plan view of still another form of the food and beverage tray of the invention as it appears in a transport and storage configuration.

FIG. 11 is a fragmentary, generally perspective, diagrammatic view illustrating the method of erection of the tray from the planar storage and shipment configuration shown in FIG. 10 to the usable configuration shown in FIG. 13.

FIG. 12 is a fragmentary, generally perspective view further illustrating the method of erection of the tray and illustrating the manner in which the foldable support member of the tray is interlocked with the bottom panel of the tray.

FIG. 13 is a generally perspective view showing the food and beverage tray of this latest form of the invention in an erected, ready to use configuration.

FIG. 14 is a top plan view of the food and beverage tray shown in FIG. 13.

FIG. 15 is a bottom plan view of the food and beverage tray shown in FIG. 13.

FIG. 16 is a front view of the food and beverage tray shown in FIG. 13.

FIG. 17 is a rear view of the food and beverage tray shown in FIG. 13.

FIG. 18 is a right end view thereof.

FIG. 19 is a left end view thereof.

FIG. 20 is a fragmentary, generally perspective diagrammatic view illustrating the manner of carrying the food and beverage tray with the user's thumb in stabilizing engagement with the lower portion of the beverage container.

### DESCRIPTION OF THE INVENTION

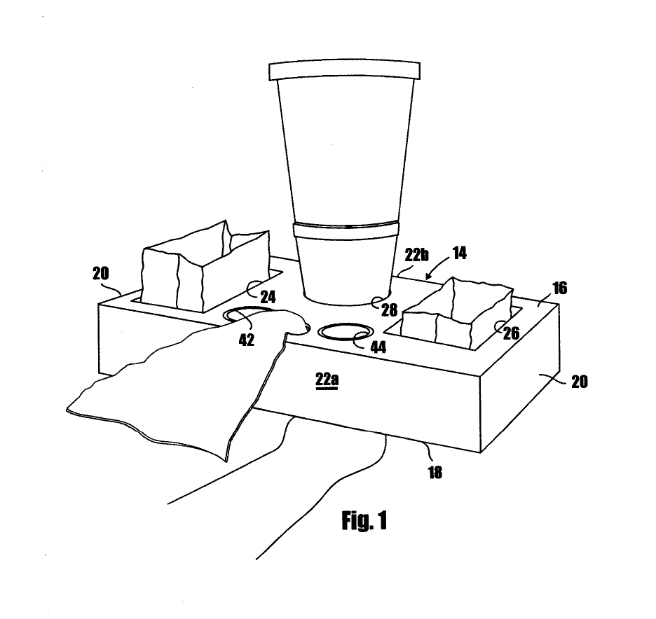

Referring to the drawings and particularly to FIG. 1, one form of the food and beverage tray of the present invention is there shown and generally identified by the numeral 14. The beverage tray here comprises a boxlike structure having interconnected top, bottom and end walls 16, 18 and 20 respectively and front and rear sidewalls 22a and 22b respectively. As best seen in FIG. 4 of the drawings, top wall 16 is provided with two longitudinally spaced food container receiving openings 24 and 26, and a centrally disposed, generally circular shaped opening 28. As illustrated in FIG. 1, openings 24 and 26 are specially designed to hold paper bags, paper wrappers, or smaller tapered trays and like containers that hold food items of various sizes. Both of the food container receiving openings 24 and 26 are provided with a pair of downwardly foldable food container engaging flaps 30 in order to accommodate and hold steady food containers of different sizes. In order to accommodate beverage containers of various diameters, a plurality of radially outward extending slits 28a circumscribe the beverage container receiving opening 28.

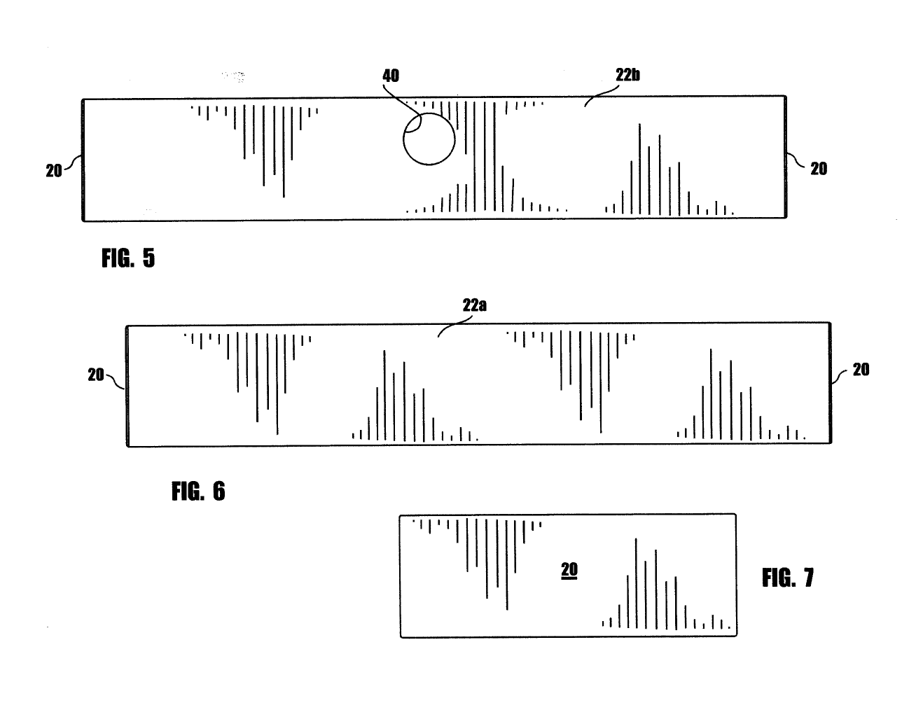

As best seen in FIG. 8 of the drawings, bottom wall 18 comprises a generally planar bottom wall having a central portion 18a provided with spaced apart first, second and third finger receiving openings 32, 34 and 36 respectively. Side walls 20a and 20b extend upward from bottom wall 18 and, for a purpose presently to be described, rear sidewall 22b is provided with a generally centrally disposed finger receiving opening 40 (see FIG. 5). End walls 20 are substantially parallel and extend upward from bottom wall 18 in the manner shown in FIG. 1 of the drawings.

In practice, the food and beverage tray can be conveniently shipped to the user in planar form and then folded into the box shape shown in the drawings at the time of use.

In the preferred form of the invention, top wall 16 further includes a pair of longitudinally spaced condiment container receiving openings 42 and 44 that are disposed intermediate the pair of longitudinally spaced food container receiving openings 24 and 26. Openings 42 and 44 can readily accommodate condiment containers of various types such as, for example, ketchup containers, mayonnaise containers, salsa containers and the like. Additionally, top wall 16 is provided with a generally centrally disposed, generally circular shaped, scored napkin receiving opening 46. As depicted in FIG. 1 of the drawings, while the food tray is being carried, one corner of the napkin can be conveniently secured within the opening until the food is to be consumed.

As can be seen in FIG. 1 of the drawings, due to the depth of the openings in which the food is placed, the food items can “stand-up” rather than lay on their sides. For example, a sandwich can stand-up, rather than lay flat. Similarly, finger foods such as French fries, chicken fingers, etc. stand-up so that they are more easily eaten.

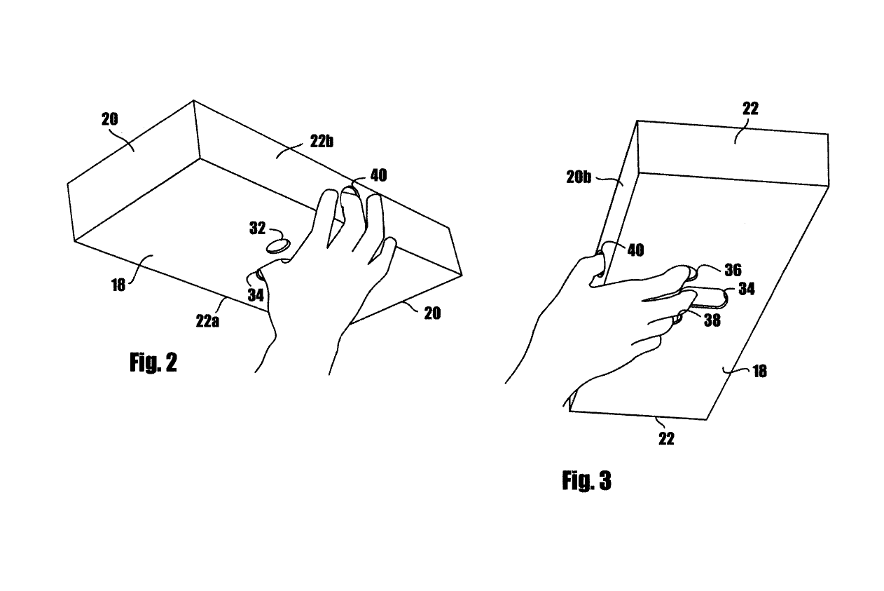

The preferred method of use of the food and beverage tray of the present invention to carry fast food items is illustrated in FIGS. 1 and 2 of the drawings. In accordance with this method, the user's thumb is positioned within generally elliptical shaped opening 34 provided in the bottom wall of the tray and the middle finger is inserted into circular opening 40 provided in sidewall 22b. The index and ring fingers are then placed in engagement with the surface of sidewall 22b in the manner shown in FIG. 2 to assist in stabilizing the tray while it is being carried.

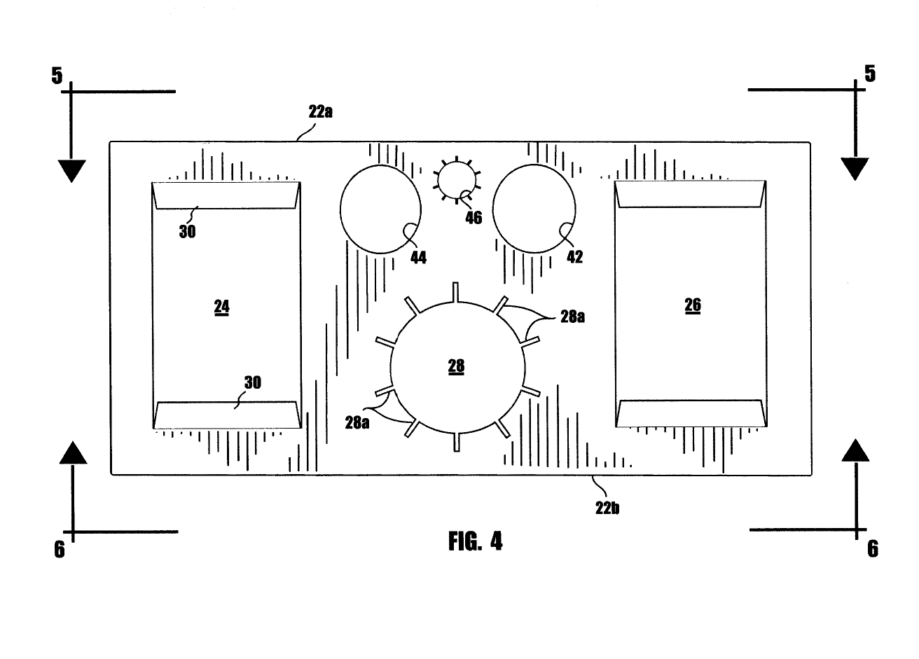

An alternate method of use of the food and beverage tray of the present invention is illustrated in FIG. 3 of the drawings. In accordance with this alternate method, the user's index finger is positioned within circular opening 36 provided in the bottom wall of the tray, the middle finger is positioned within generally elliptical shaped opening 34 and the thumb is positioned within circular opening 40 provided in sidewall 22b. The user's ring finger and little finger can then be placed in engagement with the surface of the bottom wall 18 in the manner shown in FIG. 3 to assist in stabilizing the tray while it is being carried.

By gripping the food and beverage tray of the character described in the preceding paragraphs, the fast food customer can readily carry in one hand a beverage container, two food items, condiments and a napkin. As previously mentioned, due to the strategic positioning of the thumb and finger holes of the tray on the bottom and on one side of the tray, the weight of the beverage container is uniquely disposed at the center of gravity of the tray thereby permitting the user to easily balance the tray as it is being carried. Importantly, the unique construction of the food and beverage tray as described herein enables the fast food customer to conveniently consume multiple food items and a drink without having to have a flat surface on which to place the tray.

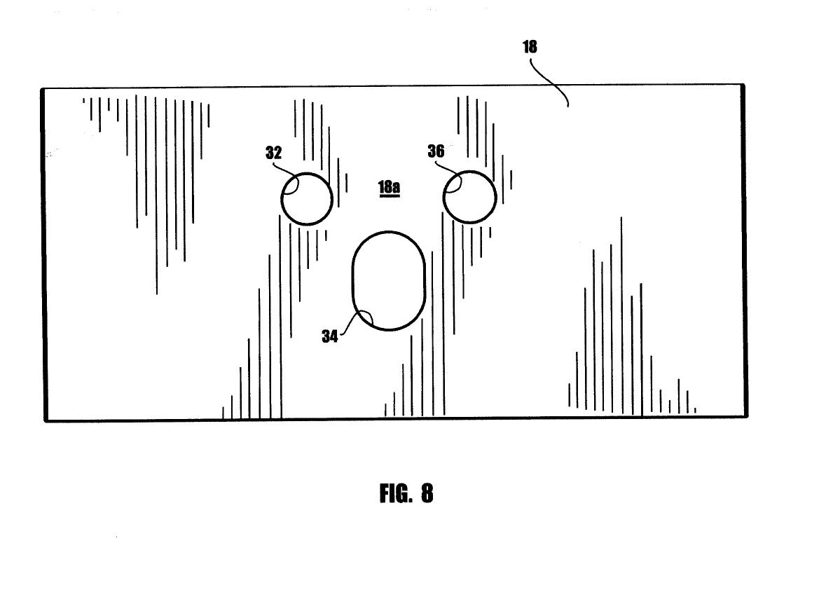

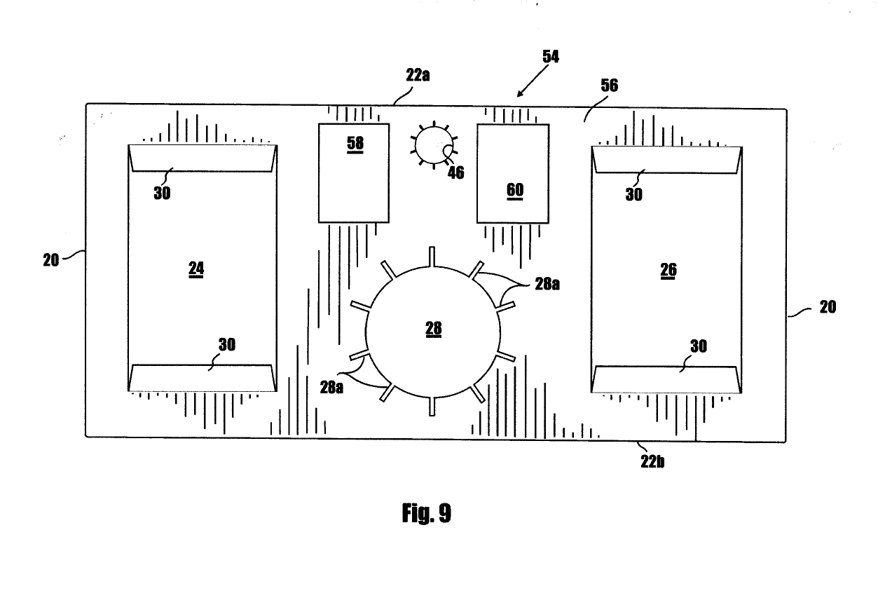

Turning now to FIG. 9 of the drawings, an alternate form of the food and beverage tray of the invention is there shown and generally designated by the numeral 54. This embodiment of the invention is similar in many respects to the embodiment shown in FIGS. 1 through 8 and like numerals are used in FIG. 9 to identify like elements. Beverage tray 54 here comprises a boxlike structure having a bottom wall that is identical in construction to bottom wall 18 and further comprises interconnected top and end walls 56 and 20 respectively and front and rear sidewalls 22a and 22b respectively. Top wall 56 is provided with two longitudinally spaced food container receiving openings 24 and 26 of identical construction and operation to those previously described, and a centrally disposed, generally circular shaped opening 28 that is also of identical construction and operation to that previously described.

In this alternate form of the invention, top wall 56 further includes a pair of longitudinally spaced, generally rectangular shaped condiment container receiving openings 58 and 60 that are disposed intermediate the pair of longitudinally spaced food container receiving openings 24 and 26. Openings 58 and 60 like the previously described openings 42 and 44 can readily accommodate condiment containers of various types such as, for example, ketchup containers, mayonnaise containers, salsa containers and the like that are packaged in rectangular shaped containers. Additionally, top wall 56 is provided with a generally centrally disposed, generally circular shaped, scored napkin receiving opening 46.

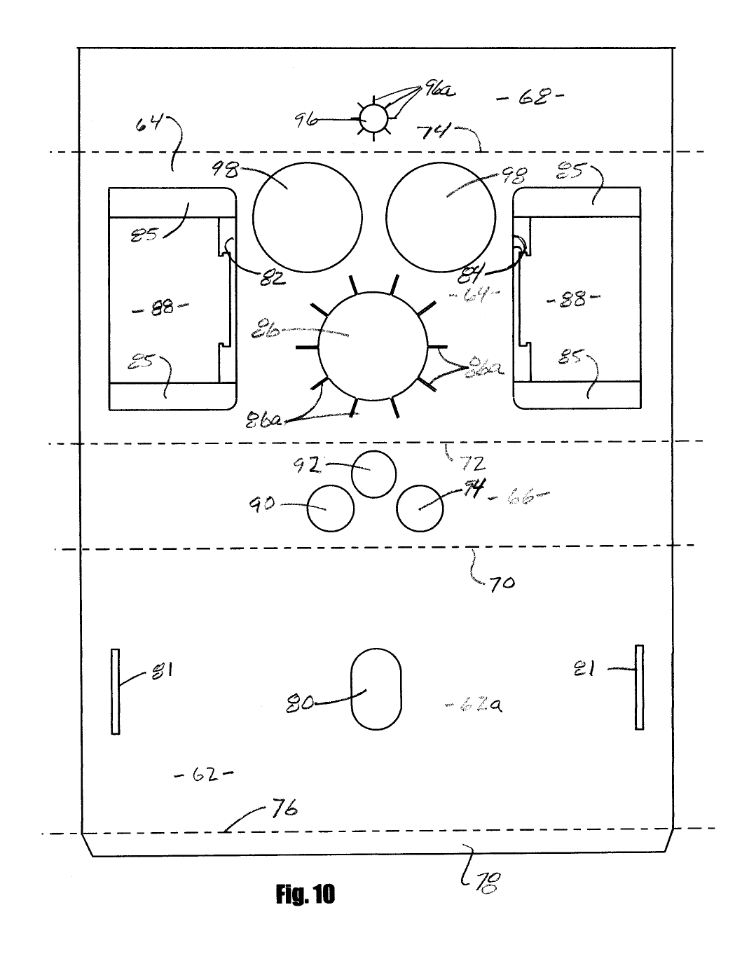

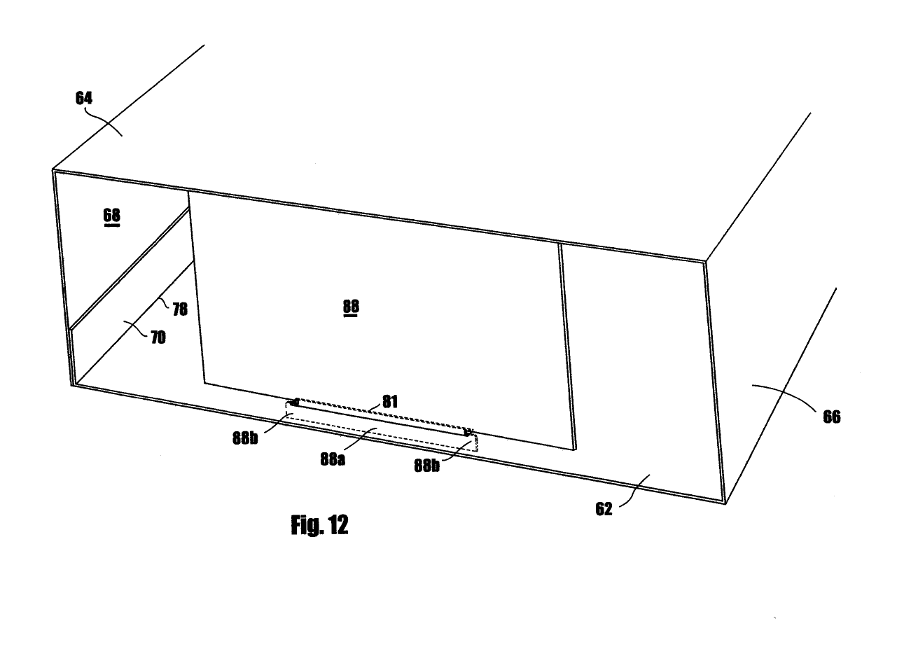

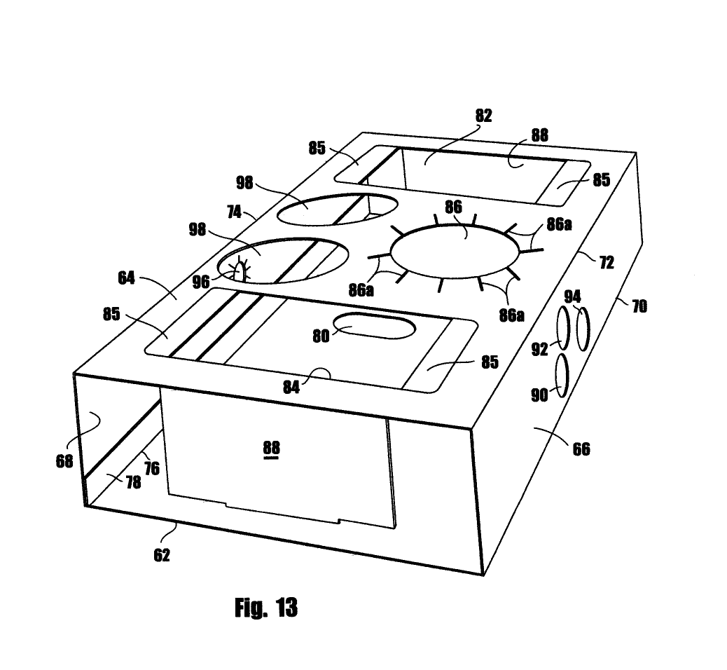

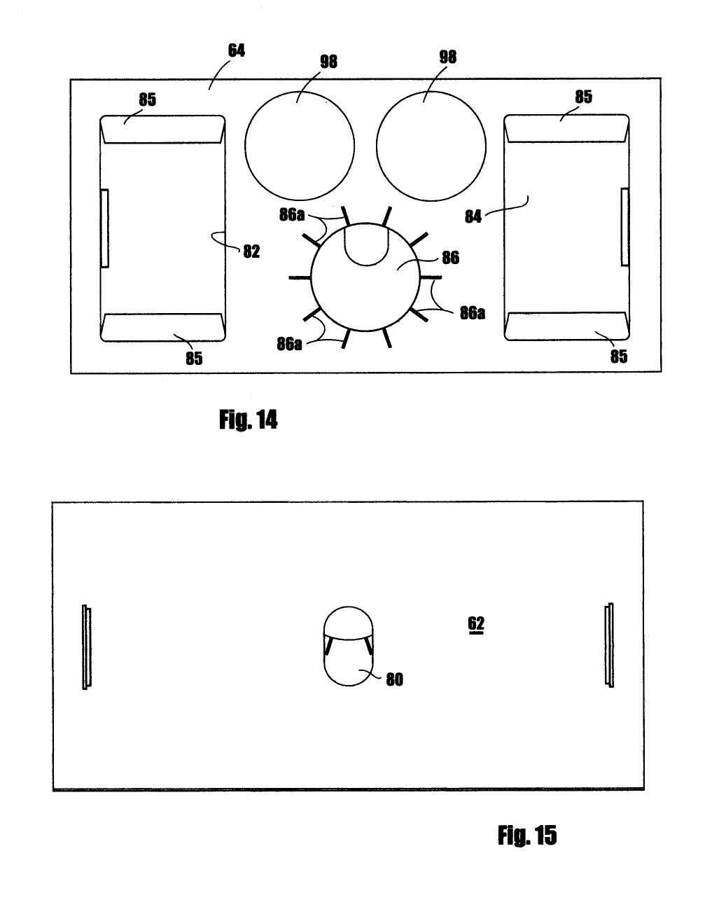

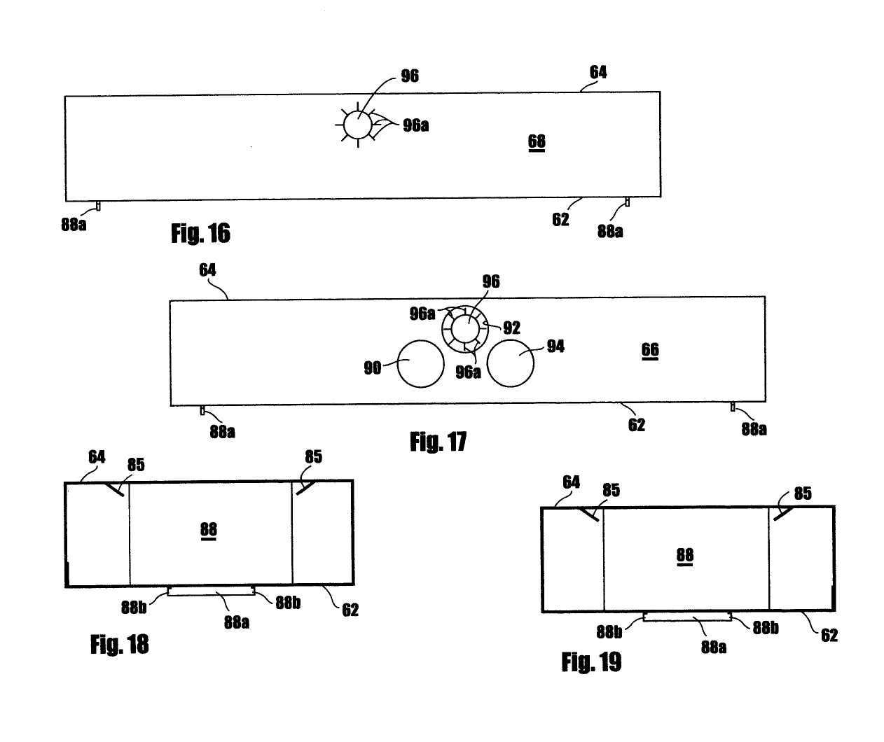

Referring next to FIG. 10 of the drawings, still another form of the food and beverage tray of the invention is there shown as it appears in a flat, pre-erected configuration. This embodiment of the invention, which is generally designated by the numeral 104, is similar in some respects to the embodiment shown in FIGS. 1 through 8, but is uniquely designed to permit expeditious erection from the generally planar configuration shown in FIG. 10 into the erected, usable configuration shown in FIG. 13. As in the earlier described embodiments of the invention, the fully erected beverage tray 104 comprises a boxlike structure having a bottom wall 62, a spaced apart top wall 64 and a pair of sidewalls 66 and 68 that are foldably connected to top wall 64.

As illustrated in FIG. 10, bottom wall 62 is connected to sidewall 66 by a fold line 70 and sidewall 66 is connected to top wall 64 by a fold line 72. Similarly, top wall 64 is connected to sidewall 68 by a fold line 74. Bottom wall 62 is provided with a fold line 76 that permits the formation of a connector flap 78 that can be connected to sidewall 68 by any suitable means such as adhesive bonding (see FIG. 13).

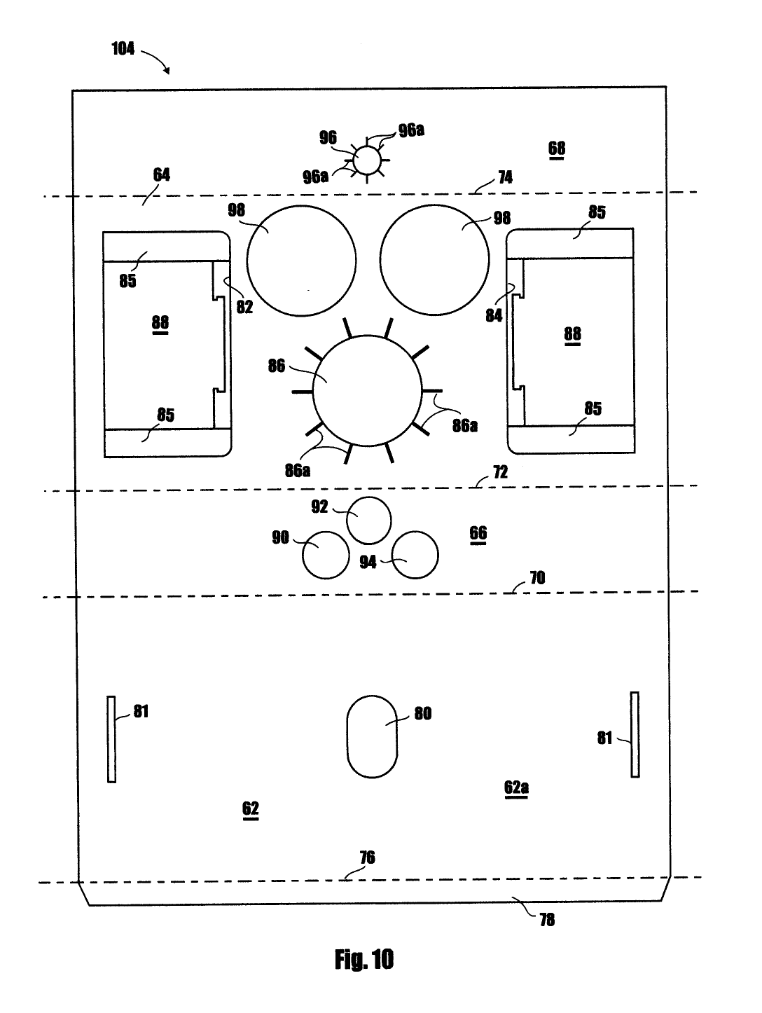

As best seen in FIGS. 10 and 13 of the drawings, bottom wall 62 comprises a generally planar wall having a central portion 62a provided with a centrally disposed, generally elliptically shaped finger receiving opening 80. Additionally, bottom wall 62 is provided with a pair of transversely spaced locking tab receiving slots 81, the purpose of which will presently be described. As indicated in FIG. 11 of the drawings, each of the tab receiving slots 81 has a first length “L”.

As in the earlier described embodiments of the invention, top wall 64 is provided with two longitudinally spaced, generally rectangular shaped food container receiving openings 82 and 84, and a centrally disposed, generally circular shaped beverage container receiving opening 86. In order to accommodate beverage containers of various diameters, a plurality of radially outward extending slits 86a circumscribe the beverage container receiving opening 86.

As before, openings 82 and 84 are provided with a pair of downwardly foldable food container engaging flaps 85 and are specially designed to hold paper bags, paper wrappers, or smaller tapered trays and like containers that hold food items of various sizes. Both of the food container receiving openings 82 and 84 are also uniquely provided with a pair of downwardly foldable, bottom wall engaging supporting flaps 88, the function of which will presently be described.

As best seen in FIGS. 10 and 11, rear sidewall 66 is provided with spaced apart first, second and third finger receiving openings 90, 92 and 94 respectively and front sidewall 68 is provided with a generally centrally disposed opening 96. Circumscribing opening 96 is a plurality of radially outward extending slits 96a which permit napkins and the like to be inserted there within.

In this latest form of the invention, top wall 64 further includes a pair of longitudinally spaced, generally circular shaped condiment container receiving openings 98 that are disposed intermediate the pair of longitudinally spaced food container receiving openings 82 and 84. Openings 98 can readily accommodate condiment containers of various types such as, for example, ketchup containers, mayonnaise containers, salsa containers and the like that are packaged in circular shaped containers.

In erecting the food and beverage tray from the pre-erected configuration shown in FIG. 10 to the erected, usable configuration, the bottom wall 62 is folded along the fold line 70, sidewall 66 is then folded along fold line 72 and sidewall 68 is folded along fold line 74 to form a partially erected tray configuration. This done, connector flap 78 is folded along fold line 76 and the connector flap is bonded to sidewall 68 in the manner shown in FIG. 13 to form the partially constructed tray there illustrated. In an alternate method of erection of the tray, the connector flap 78 can be bonded to sidewall 68 prior to the folding of the bottom wall 62 the sidewall 66 and the top wall 64 thereby permitting the pre-bonded, partially erected tray thus formed to be shipped and stored in a flat, pre-bonded configuration. This alternate method of tray erection somewhat simplifies the final erection step next to be described.

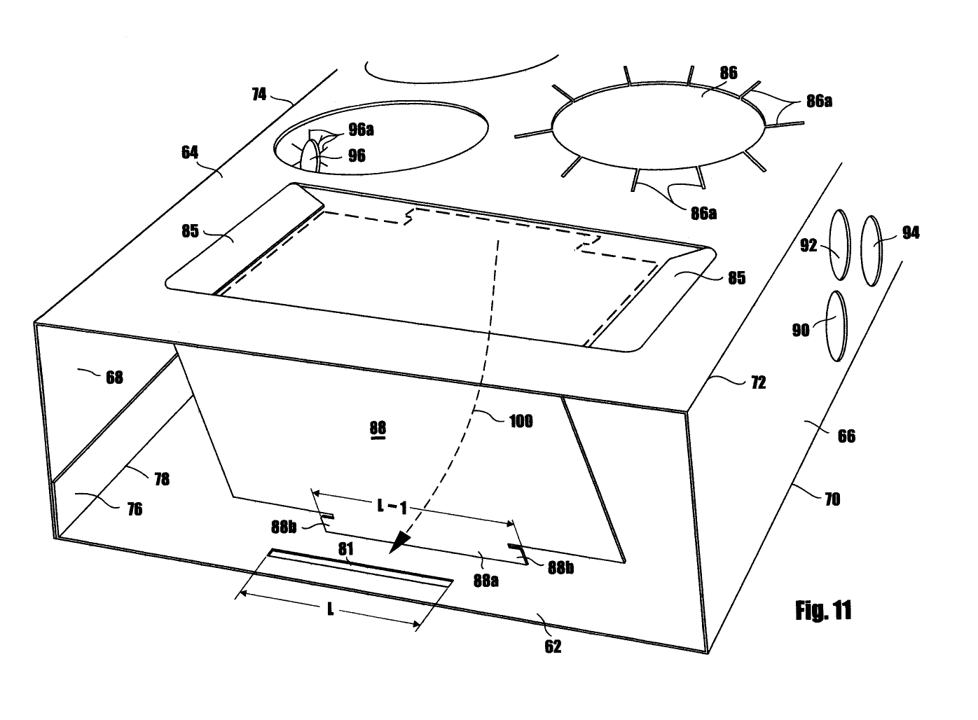

Turning particularly to FIG. 11 of the drawings, once the tray is folded into the partially erected configuration there shown, the locking flaps 88 can be folded downwardly in the direction of the arrow 100 in order to lock the tray in an erected configuration. In this regard, it is to be noted that the lower edges of each of the downwardly foldable bottom wall engaging supporting flaps 88 is provided with a locking tab 88a that has a second length “L-1” that is greater than the first length “L” of the locking tab receiving slots 81 that are formed in bottom wall 62. With this construction, it can be observed that each of the downwardly extending resiliently deformable locking tabs 88a include an outwardly extending securement ear 88b. As illustrated by the dotted lines in FIG. 12, when the flaps 88 are in the downward locking position, the locking tabs 88a extend through the locking tab receiving slots 81 and the securement ears 88b extend outwardly on either side of the slots 81 thereby restricting the accidental removal of the locking tabs from the receiving slots.

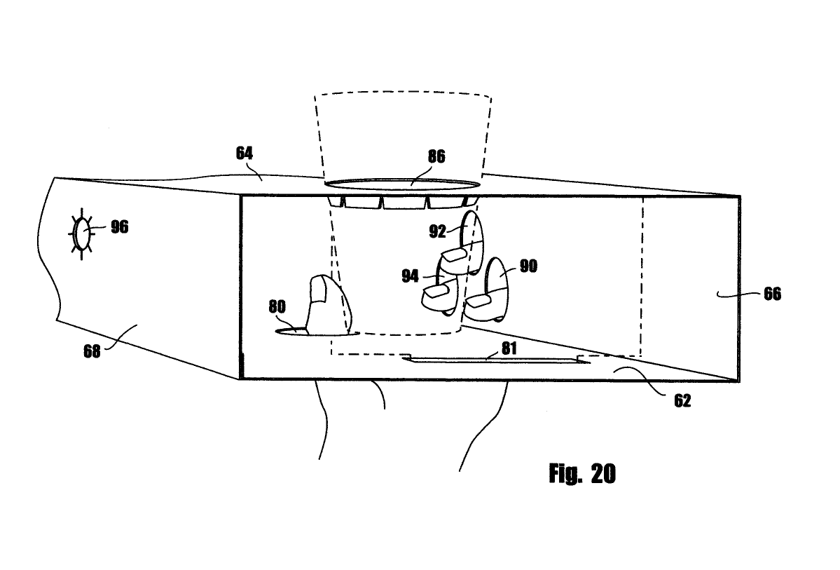

As illustrated in FIG. 20 of the drawings, in using the food and beverage tray of this latest embodiment of the invention to carry fast food items, the user's thumb is positioned within generally elliptical shaped opening 80 provided in the bottom wall of the tray and the middle finger is inserted into circular opening 92 provided in sidewall 66. The index and ring fingers are then inserted into the openings 90 and 94 provided in the sidewall 66. If desired, the little finger can be positioned in engagement with the surface of the sidewall to assist in stabilizing the tray while it is being carried.

By gripping the food and beverage tray of the character described in the preceding paragraphs, the fast food customer can readily carry in one hand a beverage container, two food items, condiments and a napkin. Due to the strategic positioning of the thumb and finger holes of the tray on the bottom and on one side of the tray in the manner illustrated in FIG. 20, when the beverage container is positioned within opening 86, the thumb of the user will engage the bottom portion of the beverage container (shown in dotted lines in FIG. 20) thereby permitting the user to easily balance the tray as it is being carried. Importantly, the unique construction of the food and beverage tray as described herein enables the fast food customer to conveniently consume multiple food items and a drink without having to have a flat surface on which to place the tray.

Accordingly, although an exemplary embodiment of the invention has been shown and described, it is to be understood that all the terms used herein are descriptive rather than limiting and that many changes, modifications, and substitutions may be made by one having ordinary skill in the art without departing from the spirit and scope of the invention, as set forth in the following claims.

I claim:

1. A food tray for carrying food articles comprising:
(a) a generally planar bottom wall having a central portion provided with a generally centrally disposed thumb receiving opening and a pair of transversely spaced locking tab receiving slots;
(b) a pair of substantially parallel side walls extending upward from said bottom wall, one of said sidewalls being provided with spaced apart first, second and third finger receiving openings;
(c) a generally planar top wall connected to said sidewalls and overlying said bottom wall, said top wall having:
(i) a pair of longitudinally spaced, generally rectangular shaped food container receiving openings, each said food container receiving opening having a downwardly foldable bottom wall engaging supporting flap; and
(ii) a generally centrally disposed, generally circular shaped beverage container receiving opening.

2. The food tray as defined in claim 1 in which each said downwardly foldable bottom wall engaging supporting flap of each said food container receiving opening is provided with a downwardly extending resiliently deformable locking tab receivable within a selected one of said pair of transversely spaced locking tab receiving slots.

3. The food tray as defined in claim 2 in which each said resiliently deformable locking tab of each said bottom wall engaging supporting flap includes outwardly extending securement ears.

4. The food tray as defined in claim 2 in which said top wall is further provided with a pair of longitudinally spaced condiment container receiving openings disposed intermediate said pair of longitudinally spaced food container receiving openings.

5. The food tray as defined in claim 2 in which said top wall is provided with a plurality of radially outward extending slits circumscribing said beverage container receiving opening.

6. The carrier as defined in claim 2 in which said first, second and third finger receiving openings are generally circular in shape.

7. The carrier as defined in claim 2 in which said thumb receiving opening is generally elliptical in shape.

8. A food tray for carrying food articles by a user having a thumb and four fingers comprising:
(a) a generally planar bottom wall having a central portion provided with a generally centrally disposed thumb receiving opening and a pair of transversely spaced locking tab receiving slots of the first length;
(b) a pair of substantially parallel side walls extending upward from said bottom wall, one of said sidewalls being provided with spaced apart first, second and third finger receiving openings;
(c) a generally planar top wall connected to said sidewalls and overlying said bottom wall, said top wall having:
(i) a pair of longitudinally spaced, generally rectangular shaped food container receiving openings, each said food container receiving opening having a downwardly foldable bottom wall engaging supporting flap having a downwardly extending locking tab of a second length greater than said first length, said locking tab being receivable within a selected one of said transversely spaced locking tab receiving slots of said bottom wall; and
(ii) a generally centrally disposed, generally circular shaped beverage container receiving opening, said beverage container receiving opening being located relative to said thumb receiving opening whereby when carrying said tray, the thumb of the user extends toward said beverage receiving opening.

9. The food tray as defined in claim 8 in which each said resiliently deformable locking tab of each said bottom wall engaging supporting flap includes outwardly extending securement ears.

10. The food tray as defined in claim 8 in which said bottom wall includes a connector flap constructed and arranged to interconnect said bottom wall with a selected one of said sidewalls.

11. The food tray as defined in claim 8 in which said top wall is further provided with a pair of longitudinally spaced condiment container receiving openings disposed intermediate said pair of longitudinally spaced food container receiving openings.

12. The food tray as defined in claim 8 in which said top wall is provided with a plurality of radially outward extending slits circumscribing said beverage container receiving opening.

13. The food tray as defined in claim 8 in which said first, second and third finger receiving openings are generally circular in shape.

14. The food tray as defined in claim 8 in which said thumb receiving opening is generally elliptical in shape.

15. A food tray for carrying food articles by a user having a thumb and four fingers comprising:
(a) a generally planar bottom wall having a central portion provided with a generally centrally disposed thumb receiving opening and a pair of transversely spaced locking tab receiving slots of a first length;
(b) a pair of substantially parallel side walls extending upward from said bottom wall, one of said sidewalls being provided with spaced apart first, second and third finger receiving openings;
(c) a generally planar top wall connected to said sidewalls and overlying said bottom wall, said top wall having:
(i) a pair of longitudinally spaced, generally rectangular shaped food container receiving openings, each said food container receiving opening having a downwardly foldable bottom wall engaging supporting flap having a downwardly extending locking tab receivable within a selected one of said transversely spaced locking tab receiving slots of said bottom wall, each said resiliently deformable locking tab of each said bottom wall engaging supporting flap being of a second length greater than said first length of said locking tab receiving slots and having outwardly extending securement ears; and
(ii) a generally centrally disposed, generally circular shaped beverage container receiving opening, said beverage container receiving opening being located relative to said thumb receiving opening whereby when carrying said tray, the thumb of the user extends toward said beverage receiving opening.

16. The food tray as defined in claim 15 in which said bottom wall includes a connector flap constructed and arranged to interconnect said bottom wall with a selected one of said sidewalls.

17. The food tray as defined in claim 15 in which said top wall is provided with a generally centrally disposed, generally circular shaped scored napkin receiving opening.

18. The food tray as defined in claim 15 in which said top wall is provided with a plurality of radially outward extending slits circumscribing said beverage container receiving opening.

19. The food tray as defined in claim 15 and which said first and second finger receiving openings are generally circular in shape and in which said third finger receiving opening is generally elliptical in shape.

20. The food tray as defined in claim 15 in which said pair of longitudinally spaced condiment container receiving openings are generally circular in shape.
